(19) United States
(12) Patent Application Publication
(10) Pub. No.: US 2004/0137260 A1
(43) Pub. Date: Jul. 15, 2004

(54) Copper clad aluminum core composite material suitable for making a cellular telephone transmission tower antenna

(75) Inventors: William A. Groll, McMurray, PA (US); John Milnthorp, McMurray, PA (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(73) Assignee: CLAD METALS LLC

(21) Appl. No.: 10/717,301

(22) Filed: Nov. 19, 2003

Related U.S. Application Data
(60) Provisional application No. 60/427,460, filed on Nov. 19, 2002.

(51) Int. Cl. B32B 15/00; B32B 15/20; B23K 31/02

(52) U.S. Cl. 428/652; 228/235.2; 228/254

(57) ABSTRACT

A method of making a composite metal material comprising the steps of providing two outer layers of copper pre-bonded to a pure aluminum such as 1100 series aluminum or to an aluminum alloy such as 3003 aluminum alloy; providing a core layer of alclad aluminum, comprising a composite having a core of aluminum alloy pre-bonded to outer layers of substantially pure 1100 series aluminum; placing the outer layers of copper pre-bonded material on either side of the alclad core layer such that the aluminum layer carried by each copper layer is facing the alclad core layer to form a stacked pack; heating the stacked pack assembled in step (c) to a suitable rolling temperature, such as about 650° F.; and hot rolling the stacked pack in a rolling mill at incremental reductions to roll bond the layers to a desired finished thickness. The invention is also directed to the composite material made according to the above-described method and to a cellular telephone transmission tower antenna made from said composite material.

### CROSS-REFERENCE TO RELATED APPLICATION

This application claims the benefit of U.S. Provisional Application No. 60/427,460 filed Nov. 19, 2002, entitled “Copper Clad Aluminum Core Composite Material and Method of Making Same”.

### BACKGROUND OF THE INVENTION

1. Field of the Invention

The invention relates generally to the manufacture of composite metal sheets and, more particularly, to a method of making a composite metal comprising an aluminum core having outermost layers of copper which is particularly useful in making an antenna for a cellular telephone transmission tower.

2. Description of Related Art

There is a great demand for an improvement in the transmission properties of cellular telephone tower antennae so as to increase the number of telephone transmissions carried by each. A preferred material to achieve this goal is copper due to its excellent electrical and thermal properties. Unfortunately, copper is a relatively heavy material and its sheer weight makes it unattractive in this application. It would, thus, be desirable to make a composite material having a copper layer on the outside with a lightweight aluminum core.

It is well-known in the cookware art to make cooking utensils (such as fry pans, stock pots, griddle plates and the like) from composite metal structures having a copper core with aluminum stainless steel outer layers or with an aluminum core and stainless steel and/or copper forming the decorative outer layer. Such cookware structures are disclosed in U.S. Pat. Nos. 6,267,830; 6,109,504; and 6,427,904 to William A. Groll, which are incorporated by reference herein. As noted in U.S. Pat. No. 6,109,504, it is very difficult to bond copper to aluminum due to the different properties of the surface oxides of each material. Aluminum oxide is very brittle while copper oxide is very ductile. In the above-referenced '504 patent, an explosion bonding step is used to join a heavy, thick plate of copper to outer layers of aluminum as one step in making a copper core griddle plate. Needless to say, the explosion bonding step as well as the subsequent heating and incremental rolling steps add expense to the process.

To our knowledge, no cookware composite has ever contained an aluminum core with outer layers of copper as proposed herein, nor has any such composite been proposed for use as a radio wave antenna. As stated, the differences in the surface oxides of copper and aluminum make it difficult to join these materials, particularly in the thin gauge thicknesses (about 0.050 inch) required for the antenna application in contrast to the prior griddle plate of 0.25 to 1.0 inch in thickness.

### SUMMARY OF THE INVENTION

According to the process of the present invention, a composite sheet comprising outer layers of copper and a core layer of aluminum is roll bonded in a thickness suitable for subsequent manufacture of useful articles such as a cellular telephone transmission tower antenna and the like. The present invention, thus, comprises a method for making a copper clad aluminum core composite material suitable for the subsequent manufacture of transmission tower antennae, as well as the composite material made by the process.

Briefly stated, the method of the present invention, as presently embodied, comprises the steps of.

(a) providing two outer layers of copper pre-bonded to a pure aluminum such as 1100 series aluminum or pre-bonded to an aluminum alloy such as 3003 aluminum alloy, referred to hereinafter as “copper pre-bonded material”;

(b) providing a core layer of alclad aluminum, comprising a composite having a core of aluminum alloy pre-bonded to outer layers of substantially pure 1100 series aluminum;

(c) placing the outer layers of copper pre-bonded material on either side of the alclad core layer such that the aluminum layer carried by each copper layer is facing the alclad core layer to form a stacked pack;

(d) heating the stacked pack assembled in step (c) to a suitable rolling temperature, such as about 650° F.; and

(e) hot rolling the stacked pack in a rolling mill at incremental reductions to roll bond the layers to a desired finished thickness.

The composite material may be given a light anneal and allowed to cool to ambient room temperature. The annealed material may subsequently be stretcher leveled to achieve the required flatness and then trimmed to a desired size/configuration.

### BRIEF DESCRIPTION OF THE DRAWINGS

FIG. 1 is a cross-sectional side view of a stacked array or pack of metal layers prior to roll bonding in the method of the present invention; and

FIG. 2 is a cross-sectional side view of the composite metal material according to the present invention after roll bonding the pack of FIG. 1.

### DETAILED DESCRIPTION OF THE INVENTION

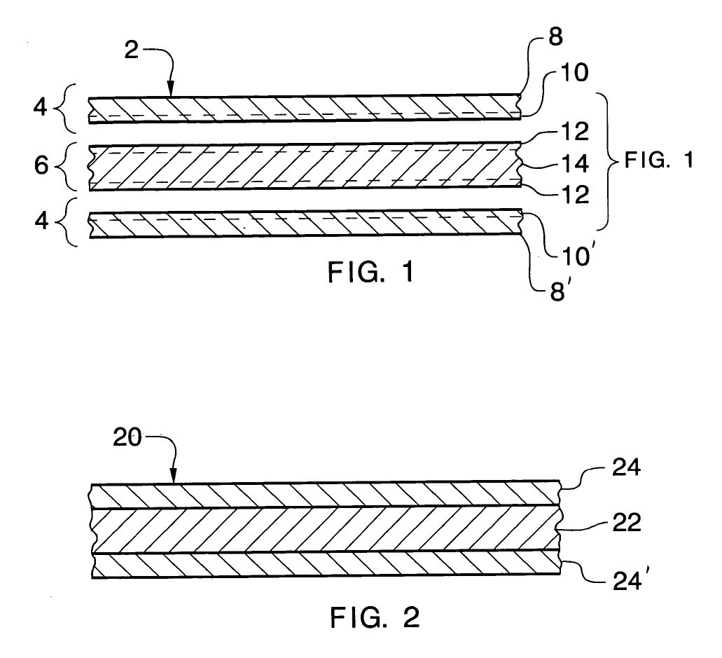

With reference to the drawings, FIG. 1 depicts a stacked array or pack 2 of metal layers 4, 4′ and 6 prior to roll bonding to produce a finished roll bonded composite 20 of the invention shown in FIG. 2.

It will be understood that the following description represents a presently preferred example of the invention and in no way should be construed as limiting the scope of the present invention.

The starting materials are provided as follows. First and second outer layers 4 and 4′ each have a copper layer 8, 8′ pre-bonded to an aluminum layer 10, 10′, respectively. The copper layers 8, 8′ are preferably of 102 copper alloy. Of course, other copper alloys or pure copper may be used. The aluminum layers 10, 10′ are of a high purity aluminum such as an 1100 aluminum or they may be 3003 aluminum alloy. The starting thickness of the layers 4 and 4′ are preferably on the order of about 0.035 inch wherein the thickness of the copper layers 4 and 4′ comprise about 0.028 inch each layer while the thickness of the high purity aluminum layers 10, 10′ comprises the balance, about 0.007 inch in each layer 4, 4′.

The aluminum core layer 6 in the starting stacked array or pack 2 of FIG. 1 is preferably a sheet of alclad aluminum material which comprises a known pre-bonded composite made up of high purity aluminum layers 12, 12′ such as 1145 aluminum, bonded on either side of a higher strength aluminum alloy core 14 such as 3004 aluminum alloy. The preferred thickness of the alclad core layer 6 may be on the order of 0.040 to 0.080 inch, although thicknesses up to 0.16 inch or greater may be used to suit the design.

Both the pre-bonded copper layers 4, 4′ and alclad core layer 6 are commercially available products in and of themselves. The pre-bonded copper for layers 4, 4′ is preferably the fully annealed condition prior to forming the stacked array 2, but other tempers may be employed.

Prior to roll bonding, the layers 4, 4′ and 6 are cut to sheet lengths (if supplied in coils) that will produce a desired product length after rolling reduction plus a margin to allow for post rolling stretcher leveling. The cut sheets of layers 4, 4′ and 6 are then treated by abrasive grinding or wire wheel treating prior to rolling. More particularly, the exposed faces of the aluminum layers 10 and 10′ of the copper sheets 4, 4′ and the exposed faces of the aluminum layers 12, 12′ of the alclad core sheet 6 are surface ground with 60 grit abrasive belts or wire brushes to remove surface oxides. The layers 4, 6 and 4′ are then stacked as shown in FIG. 1 to form a roll pack 2 such that the abrasively ground or wire brush treated surfaces of layer 10 and layer 12, as well as layer 10′ and layer 12′, contact one another.

The pack 2 is then placed in a furnace and heated to rolling temperature, for example, about 650° F. The furnace need not contain any special atmosphere since the prebonded layers 4, 6 and 4′ of the pack 2 are configured to contend with an oxygen-containing atmosphere. Hence, the method of the present invention requires no expensive vacuum treatment or other expensive and/or potentially hazardous special atmospheric furnaces to metallurgically bond aluminum to copper, as is conventionally required.

After the assembled pack 2 has been heated to a desired rolling temperature, preferably about 650° F., the pack 2 is reduced in thickness in a rolling mill. A first pass in the rolling mill is conducted with a first thickness reduction of about 30%. Subsequent incremental roll pass reductions are taken on the rolling mill to achieve a desired finished thickness in the roll bonded composite material 20 of the present invention.

The finished rolled composite material 20 is given a light anneal heat treatment at about 650° F. and allowed to cool to ambient room temperature. The composite material 20 is then preferably subjected to a stretcher leveling step to provide the required flatness. The stretcher flattened composite material 20 is then trimmed to the required final dimensions.

After roll bonding, the finished composite material 20 of FIG. 2 comprises an aluminum core 22 and outer layers 24, 24′ of copper. The aluminum core 22 itself comprises a central core layer of 3004 aluminum alloy with layers of 1145 aluminum (from the alclad layer 6 starting material) on either side and high purity 1100 grade aluminum bonded to the 1145 or 3003 aluminum layers which, in turn, are bonded to the outer layers 24, 24′ of copper.

The finished roll bonded composite material 20 of the present invention preferably has an aluminum core 22 thickness of 0.020 inch or greater. Each of the copper layers 24, 24′ has a presently preferred nominal thickness of about 0.010 inch. Hence, the overall presently preferred thickness of the finished roll bonded composite sheet material 20 is about 0.040 inch minimum up to about 0.060 inch for use in the manufacture of a cellular telephone antenna structure. Of course, the thicknesses are non-limiting in the present invention. In this regard, we have made the finished roll bond composite sheet 20 at a final thickness of 0.125 inch for a specific application.

Thus, it can be appreciated that the composite sheet material 20 of the invention is much lighter in weight compared with a sheet of solid copper of the same thickness, since at least one-half the thickness of the composite material 20 is made up of lightweight aluminum in the core 22. In addition, the positioning of the higher yield and tensile strength copper layers 24, 24′ placed over the aluminum core 22 provides a composite structure having a higher radius of gyration. This results in a lightweight composite that has superior structural rigidity for the intended application. The presently preferred symmetrical make-up of the composite material 20 comprising aluminum core 22 with equal thicknesses of copper layers 24, 24′ on opposite sides thereof ensure flatness and non-warpage or other shape changes due to unequal thermal contraction or expansion. It will be appreciated, however, that asymmetrical arrangements are possible without departing from the spirit or scope of the invention.

The bonded composite material 20 is then formed by conventional means into a desired antenna configuration. The antenna provides excellent electrical characteristics due to its copper clad outer surfaces, and is relatively lightweight yet structurally strong due to its aluminum alloy core.

In addition, the continuous roll bonded composite structure 20 contains no joints, gaps or spaces between the layers 24, 22 and 24′ which might otherwise be present if separate sheets of aluminum and copper were welded or brazed together. Such joints, welds or braze areas would likely interfere with electrical resistivity and induce unwanted eddy currents from radio wave energy.

What is claimed is:

1. A method of making a composite metal material comprising the steps of:
(a) providing two outer layers of copper pre-bonded to a pure aluminum such as 1100 series aluminum or to an aluminum alloy such as 3003 aluminum alloy;
(b) providing a core layer of alclad aluminum, comprising a composite having a core of aluminum alloy pre-bonded to outer layers of substantially pure 1100 series aluminum;
(c) placing the outer layers of copper pre-bonded material on either side of the alclad core layer such that the aluminum layer carried by each copper layer is facing the alclad core layer to form a stacked pack;
(d) heating the stacked pack assembled in step (c) to a suitable rolling temperature, such as about 650° F.; and
(e) hot rolling the stacked pack in a rolling mill at incremental reductions to roll bond the layers to a desired finished thickness.

2. The composite metal material made according to the method of claim 1.

3. A method of making a cellular telephone transmission tower antenna from a composite metal material comprising the steps of:
(a) providing two outer layers of copper pre-bonded to a pure aluminum such as 1100 series aluminum or to an aluminum alloy such as 3003 aluminum alloy;
(b) providing a core layer of alclad aluminum, comprising a composite having a core of aluminum alloy pre-bonded to outer layers of substantially pure 1100 series aluminum;
(c) placing the outer layers of copper pre-bonded material on either side of the alclad core layer such that the aluminum layer carried by each copper layer is facing the alclad core layer to form a stacked pack;
(d) heating the stacked pack assembled in step (c) to a suitable rolling temperature, such as about 65020 F.;
(e) hot rolling the stacked pack in a rolling mill at incremental reductions to roll bond the layers to a desired finished thickness to provide a composite metal sheet; and
(f) forming the composite metal sheet of step (e) into a desired antenna configuration.

4. A composite metal material comprising a core layer of aluminum alloy having layers of pure aluminum roll bonded on either side of said core layer with layers of pure aluminum or aluminum alloy roll bonded to said layers of pure aluminum and layers of copper defining the outer skin of said composite metal material roll bonded to said layers of pure aluminum or aluminum alloy.

5. A cellular telephone transmission tower antenna made from the composite metal material of claim 4.

6. A cellular telephone transmission tower antenna made from a composite metal material comprising a core layer of aluminum alloy having layers of pure aluminum roll bonded on either side of said core layer with layers of pure aluminum or aluminum alloy roll bonded to said layers of pure aluminum and layers of copper defining the outer skin of said composite metal material roll bonded to said layers of pure aluminum or aluminum alloy.
